(19) United States
(12) Patent Application Publication
(10) Pub. No.: US 2013/0270281 A1
(43) Pub. Date: Oct. 17, 2013

(54) DEVICE WITH STRUCTURE ENHANCING MECHANISM

(71) Applicant: HONG LI, Shenzhen City (CN)

(72) Inventor: HONG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/615,655

(22) Filed: Sep. 14, 2012

(30) Foreign Application Priority Data
Apr. 16, 2012 (CN) 201210109823.9

(51) Int. Cl. G06F 1/16

(52) U.S. Cl. 220/676

(57) ABSTRACT

A device with a structure enhancing mechanism includes: a housing including a sidewall, the sidewall defining a first through hole; a retaining member formed on an inner surface of the sidewall, the retaining member including a first protruding tab substantially parallel to the sidewall; two first resisting members extending from the first protruding tab toward the sidewall, an edge of each first resisting member spaced from and parallel to the sidewall; two second resisting members extending from the inner surface of the sidewall, the two second resisting members facing the respective first resisting members and two gaps being respectively formed between the first resisting members and the second resisting members; a fixing plate engaged in the gap and being firmly sandwiched between the first resisting members and the second resisting members, the fixing plate defining a second through hole aligned with the first through hole.

### BACKGROUND

1. Technical Field

The present disclosure relates to devices with structure enhancing mechanism.

2. Description of Related Art

Devices, such as a portable computer, may be tied to a leg of a desk to prevent it from being stolen. In detail, a through hole may be defined in a case of the device, and one end of a cord may extend through the through hole and is fastened to the device, and the other end is fastened to the desk, thereby tying the device to the desk. When a person tries pick up the device, a pull force may be applied to the device via the cord.

However, when the case of the device is made of plastic, a repeated pull force may damage the case.

Therefore, what is needed is a means to solve the problem described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a partially disassembled perspective view of a device with a steady mechanism in accordance with an exemplary embodiment.

FIG. 2 is a sectional view enlarging a steady mechanism portion of the device shown in FIG. 1.

FIG. 3 is an assembled perspective view of the device show in FIG. 1.

FIG. 4 is a cross-sectional view of the device shown in FIG. 3.

### DETAILED DESCRIPTION

Embodiments of the present disclosure will now be described in detail, with reference to the accompanying drawings.

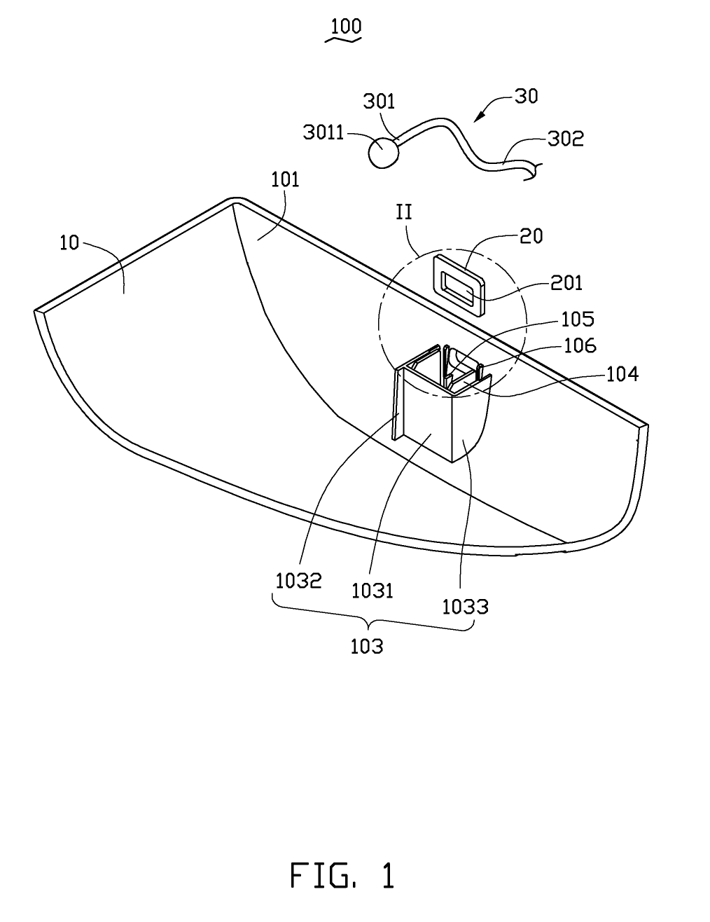

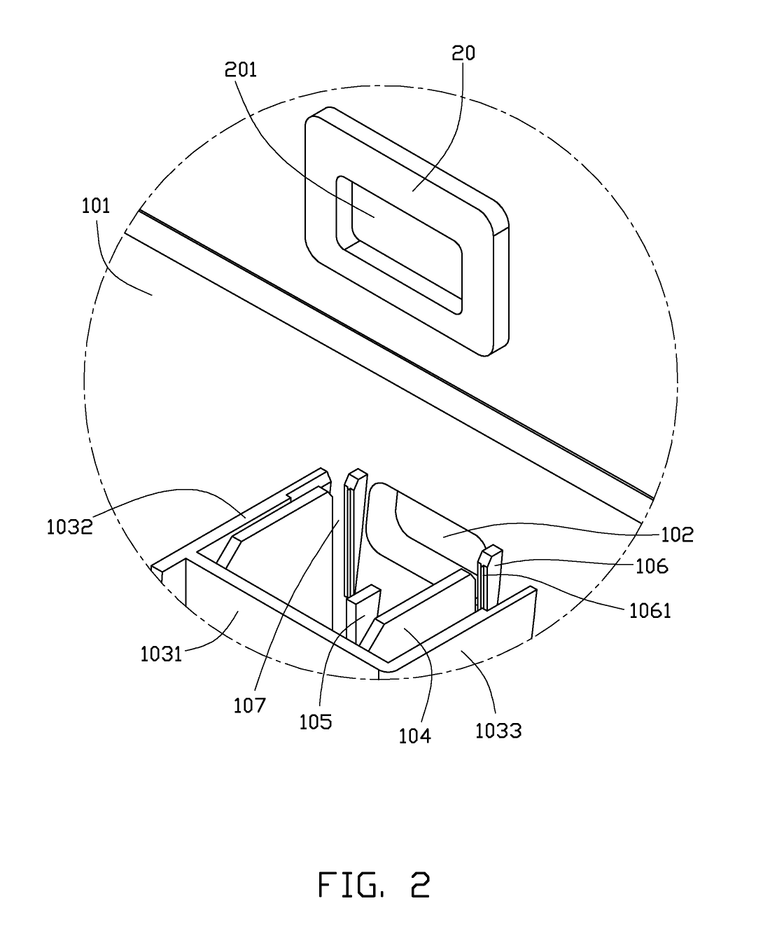

FIGS. 1-2 are isometric views of an exemplary embodiment of a device 100 with an upper cover omitted for clarity. The device 100 includes a bottom cover 10 defining a receiving space for receiving components (not shown) of the device 100. The bottom cover 10 includes a sidewall 101. A first through hole 102 is defined in the sidewall 101. A cord 30 may extend through the first through hole 102 to tie the device 100 to a stationary object, such as a leg of a desk, to prevent the device 100 from being stolen.

A retaining member 103 is formed on the inner surface of the sidewall 101 adjacent to the first through hole 102. The retaining member 103 includes a first protruding tab 1031, a second protruding tab 1032, and a third protruding tab 1033. The second protruding tab 1032 and the third protruding tab 1033 are substantially perpendicularly protruding from the sidewall 101. The first through hole 102 is located between the second protruding tab 1032 and the third protruding tab 1033. The first protruding tab 1031 is interconnected between the second protruding tab 1032 and the third protruding tab 1033. The first protruding tab 1031 is parallel to the sidewall 101.

Two first resisting members 104 extend from the first protruding tab 1031 toward the sidewall 101. The first resisting members 104 are located between the second protruding tab 1032 and the third protruding tab 1033. The distal edge of each of the first resisting members 104 is spaced apart a distance from and parallel to the sidewall 101.

A supporting member 105 protrudes from the inner surface of the sidewall 101 and is located under the first through hole 102.

Two second resisting members 106 extend from the inner surface of the sidewall 101 and are located between the second protruding tab 1032 and the third protruding tab 1033. The two second resisting member 106 are respectively located at two opposite sides of the first through hole 102. The two second resisting members 106 respectively face the two first resisting members 104. Two gaps 107 are respectively formed between the first resisting members 104 and the second resisting members 106. In the embodiment, each second resisting member 106 further includes a project portion 1061 protruding from a surface facing the corresponding first resisting member 104.

A fixing plate 20 engaged in the gaps 107 and is firmly sandwiched between the first resisting members 104 and the second resisting members 106. A second through hole 201 is defined in the center of the fixing plate 20. In the embodiment, the fixing plate 20 is made of metal.

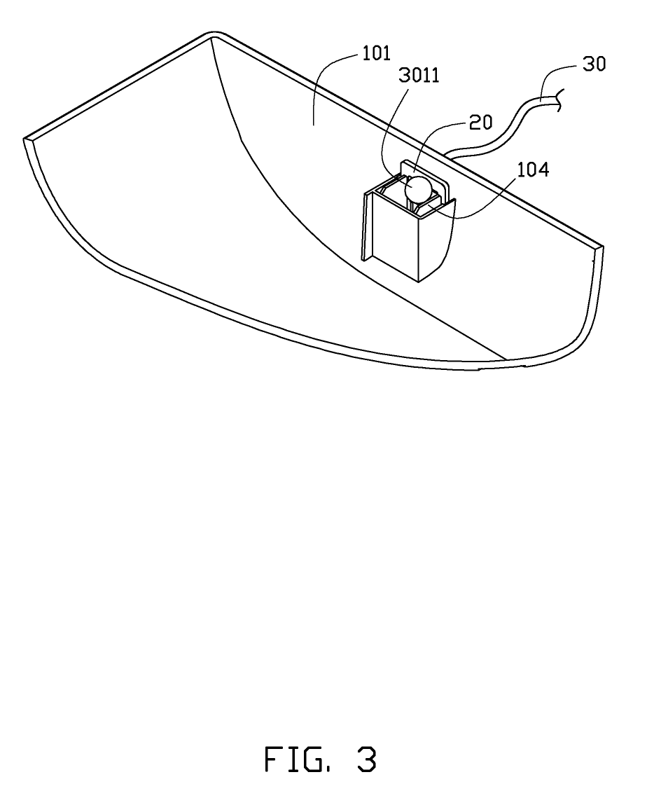

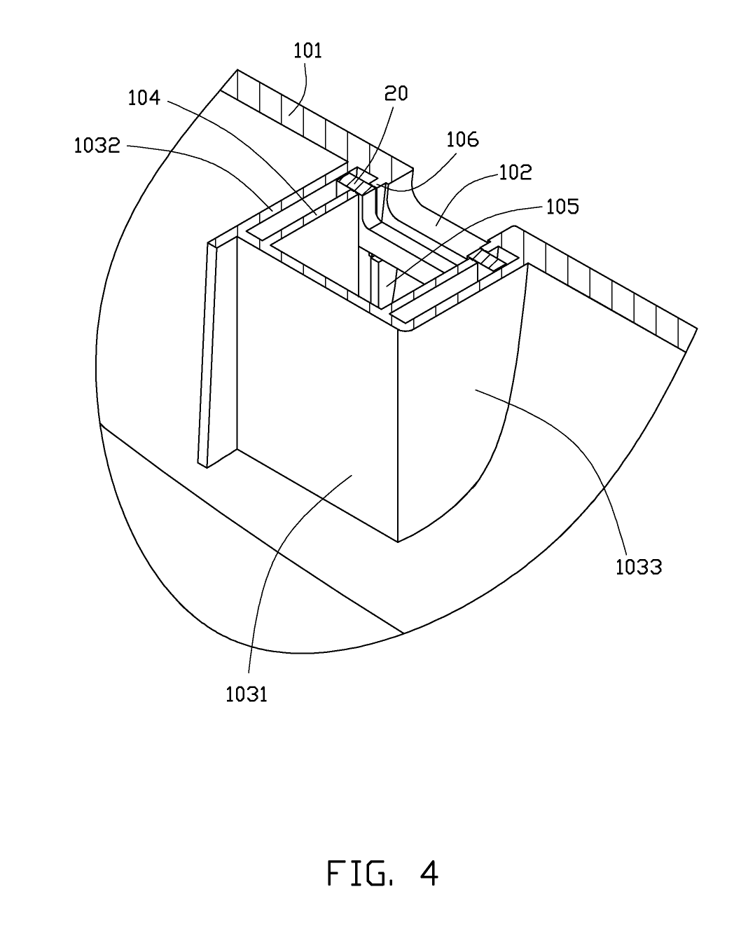

Referring to FIGS. 3-4, in assembly, the fixing plate 20 is engaged in the gaps 107, with the second through hole 201 aligned with the first through hole 102 of the sidewall 101. The first resisting members 104 and the second resisting members 106 cooperatively clamp the plate 20 and restrict the movement of the plate 20 in a direction that is perpendicular to sidewall 101. The second protruding tab 1032 and the third protruding tab 1033 respectively resist against two opposite ends of the plate 20 to restrict the movement of the plate 20 in a direction parallel to the sidewall 101. The supporting member 105 supports the plate 20.

In the embodiment, the distance between the first resisting members 104 and the second resisting members 106 is equal to the thickness of the plate 20. A first end 301 of the cord 30 can extend through the first through hole 102 and the second through hole 201, and the first end 301 forms a loop 3011 secured to the fixing plate 20 and the sidewall 101. A second end 302 of the cord 30 can be fastened to a stationary object, thereby tying the electronic device 100 to the stationary object. When the second end 302 of the core 30 is pulled by an external force, the force is first transmitted to the plate 20 and then transmitted to the sidewall 101 via the plate 20. The plate 20 and the sidewall 101 cooperatively undertake the pull force on the cord 30, thus lowering the possibility that the sidewall 101 is damaged due to excessive pull force.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A device with a structure enhancing mechanism, comprising:
a housing comprising a sidewall, the sidewall defining a first through hole;
a retaining member formed on an inner surface of the sidewall, the retaining member comprising a first protruding tab substantially parallel to the sidewall;
two first resisting members extending from the first protruding tab toward the sidewall, an edge of each first resisting member spaced from and parallel to the sidewall;
two second resisting members extending from the inner surface of the sidewall, the two second resisting members facing the respective first resisting members and two gaps being respectively formed between the first resisting members and the second resisting members;
a fixing plate engaged in the gap and being firmly sandwiched between the first resisting members and the second resisting members, the fixing plate defining a second through hole aligned with the first through hole.

2. The device as described in claim 1, further comprising a supporting member protruding from the inner surface of the sidewall and is configured for supporting the fixing plate.

3. The device as described in claim 1, wherein the retaining member further comprises a second protruding tab and a third protruding tab, the second protruding tab and the third protruding tab are perpendicular to the first protruding tab, the first protruding tab is interconnected between the second protruding tab and the third protruding tab, the second protruding tab and the third protruding tab respectively resist opposite ends of the fixing plate to restrict the movement of the fixing plate in a direction parallel to the sidewall.

4. The device as described in claim 1, further comprising a cord having an end portion extending through the first and second through hole, the end portion forming a loop secured to the fixing plate and the sidewall.
